(19) United States
(12) Patent Application Publication
(10) Pub. No.: US 2019/0224912 A1
(43) Pub. Date: Jul. 25, 2019

(54) INCORPORATING SURFACE-MODIFIED COMPONENTS IN ADDITIVELY MANUFACTURED COMPONENTS

(71) Applicants: Rolls-Royce Corporation, Indianapolis, IN (US); Rolls-Royce North American Technologies, Inc., Indianapolis, IN (US)

(72) Inventors: Quinlan Yee Shuck, Indianapolis, IN (US); Scott Nelson, Carmel, IN (US); Brandon David Ribic, Noblesville, IN (US); Matthew R. Gold, Carmel, IN (US)

(21) Appl. No.: 16/255,102

(22) Filed: Jan. 23, 2019

Related U.S. Application Data
(60) Provisional application No. 62/620,806, filed on Jan. 23, 2018.

(51) Int. Cl. B29C 64/135; B29C 64/118; B29C 64/393; B33Y 10/00; B33Y 30/00; B33Y 50/02

(52) U.S. Cl. CPC B29C 64/135; B29C 64/118; B29C 64/393; B29K 2105/0002; B33Y 30/00; B33Y 50/02; B33Y 10/00

(57) ABSTRACT

An additive manufacturing assembly may include a surface-modified component to be incorporated into an additively manufactured component by adhering the at least one component to the additively manufactured component during an additive manufacturing technique. The surface-modified component includes a modified surface that is modified to have increased adhesion to the additively manufactured component. The additive manufacturing assembly also includes means for additively forming layers of material using the additive manufacturing technique and a computing device, the computing device is configured to control the means for additively forming layers to form a layer of material on the surface of the surface-modified component and control the means for additively forming layers to form, on the layer of material, at least one additional layer of material to form the additively manufactured component incorporating the surface-modified component.

This application claims the benefit of U.S. Provisional Patent Application No. 62/620,806, filed Jan. 23, 2018, the entire contents of which are incorporated herein by reference.

### TECHNICAL FIELD

The disclosure relates to additive manufacturing techniques.

### BACKGROUND

Additive manufacturing generates three-dimensional structures through addition of material layer-by-layer or volume-by-volume to form the structure, rather than removing material from an existing volume to generate the three-dimensional structure. Additive manufacturing may be advantageous in many situations, such as rapid prototyping, forming components with complex three-dimensional structures, or the like. In some examples, additive manufacturing may include fused deposition modeling, in which heated material, such as polymer, is extruded from a nozzle and cools to be added to the structure, or stereolithography, in which an energy source is used to selectively cure a liquid photopolymer resin to a desired shape of the component.

### SUMMARY

In some examples, the disclosure describes an additive manufacturing assembly including a surface-modified component to be incorporated into an additively manufactured component by adhering the at least one component to the additively manufactured component during an additive manufacturing technique. The surface-modified component includes a modified surface that is modified to have increased adhesion to the additively manufactured component. The additive manufacturing assembly also includes means for additively forming layers of material using the additive manufacturing technique and a computing device, the computing device is configured to control the means for additively forming layers to form a layer of material on the surface of the surface-modified component and control the means for additively forming layers to form, on the layer of material, at least one additional layer of material to form the additively manufactured component incorporating the surface-modified component.

In some examples, the disclosure describes a method that includes forming, on a surface of a surface-modified component to be integrated with an additively manufactured component by adhering the surface-modified component to the additively manufactured component during an additive manufacturing technique, a layer of material using the additive manufacturing technique. The surface of the surface-modified component is modified to have increased adhesion to the layer. The method also includes forming, on the layer of material, at least one additional layer of material to form the additively manufactured component incorporating the surface-modified component.

In some examples, the disclosure describes a computer-readable storage device including instructions that, when executed, configure one or more processors of a computing device to control means for additively forming layers of material using an additive manufacturing technique to form, on a modified surface of a surface-modified component, a layer of material using an additive manufacturing technique. The modified surface is modified to have increased adhesion to the additively manufactured component, and the layer adheres to the modified surface. The computer-readable storage device also includes instructions that, when executed, configure the one or more processors of the computing device to control the means for additively forming layers of material to form, on the layer of material, at least one additional layer of material to form an additively manufactured component incorporating the surface-modified component.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a conceptual block diagram illustrating an example system for performing an additive manufacturing technique to form additively manufactured components incorporating a surface-modified component.

FIG. 2 is a conceptual block diagram illustrating another example system for performing an additive manufacturing technique to form additively manufactured components incorporating a surface-modified component.

FIGS. 3A-3H are cross-sectional diagrams illustrating examples of 3D features formed in a surface-modified component.

FIGS. 4A-4D are conceptual diagrams illustrating examples of arrays of 3D features formed in a surface-modified component.

FIG. 5 is a flow diagram illustrating an example technique for forming an additively manufactured component incorporating a surface-modified component.

### DETAILED DESCRIPTION

The disclosure generally describes techniques for forming additively manufactured components incorporating at least one surface-modified component. Some additively manufactured components may be formed from a polymer, such as epoxies, polyurethanes, polyethers, polyesters, polyolefins, polystyrene, acrylonitrile butadiene styrene, polylactic acid, aliphatic polyamides, or the like. While these polymers may adhere well to some other materials, these polymers may not adhere as well to other materials. This may make incorporating other components, such as wear resistant inserts, anti-counterfeiting devices, metal or alloy inserts, a material having a different hydrophilicity than the material used to form the additively manufactured component, or the like, into the additively manufactured component.

The disclosure describes additive manufacturing techniques for facilitating incorporation of components such as wear resistant inserts, anti-counterfeiting devices, metal or alloy inserts, a material having a different hydrophilicity than the material used to form the additively manufactured component, or the like into an additively manufactured component. The additive manufacturing techniques include utilizing surface-modified components. The surface-modified components include at least one modified surface that has been modified to increase adhesion to the additively manufactured component. For example, a surface-modified polymer component may include at least one surface that has been plasma modified to increase adhesion to the additively manufactured component. As another example, a metal or alloy-based surface-modified component may include at least one modified surface that includes three-dimensional surface features configured to improve mechanical adhesion to the additively manufactured component, e.g., by mechanical interlocks formed during the additive manufacturing technique. In this way, the techniques described herein may facilitate incorporation of other components, such as wear resistant inserts, anti-counterfeiting devices, metal or alloy inserts, a material having a different hydrophilicity than the material used to form the additively manufactured component, or the like, into an additively manufactured component.

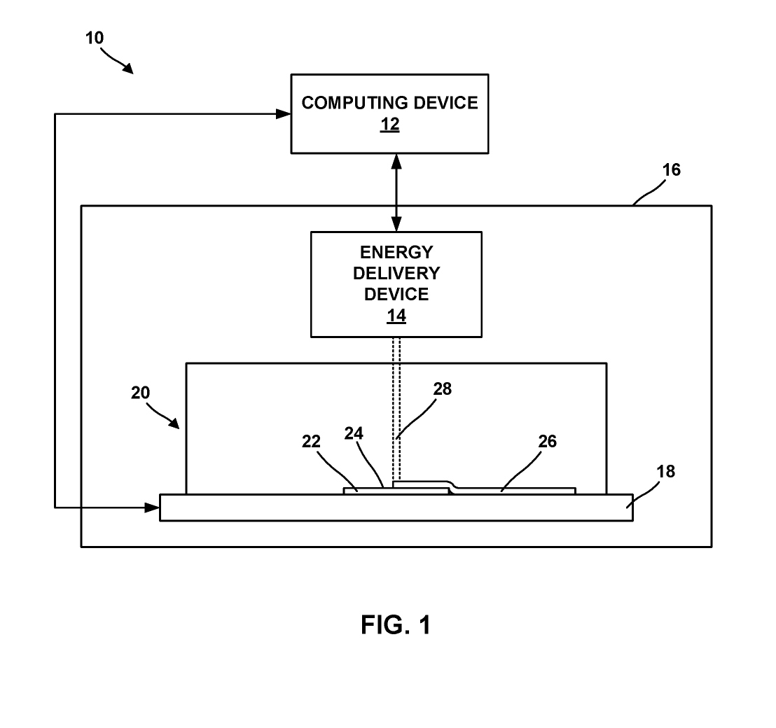

FIG. 1 is a conceptual block diagram illustrating an example additive manufacturing system 10 for performing an additive manufacturing technique to form additively manufactured components incorporating at least one surface-modified component. In the example illustrated in FIG. 1, system 10 includes a computing device 12, an energy delivery device 14, an enclosure 16, a stage 18, a vat 20, and a surface-modified component 22. Computing device 12 is operably connected to energy delivery device 14 and stage 18. In the example of FIG. 1, additive manufacturing system 10 is a stereolithographic printing system.

In some examples, additive manufacturing system 10 includes enclosure 16, which at least partially encloses energy delivery device 14, stage 18, vat 20, and surface-modified component 22. Enclosure 16 may provide physical protection to energy delivery device 14, stage 18, vat 20, and substrate 22 during operation of additive manufacturing system 10, may maintain an atmosphere within enclosure 16 in a desired state (e.g., filled with a gas that is substantially inert to a liquid photopolymer resin in vat 20 or maintained at a desired temperature), or the like.

In some examples, stage 18 is movable relative to energy delivery device 14 and/or energy delivery device 14 is movable relative to stage 18. For example, stage 18 may be translatable and/or rotatable along at least one axis to position surface-modified component 22 relative to energy delivery device 14. Similarly, energy delivery device 14 may be translatable and/or rotatable along at least one axis to position energy delivery device 14 relative to surface-modified component 22. Stage 18 may be configured to selectively position and restrain surface-modified component 22 in place relative to stage 18 during manufacturing of the additively manufactured component.

Vat 20 may be positioned on stage 18 and may contain a liquid photopolymer resin. The photopolymer may include oligomers, such as epoxides, urethanes, polyethers, polyesters, or mixtures thereof. In some examples, the oligomers may be functionalized by a reactive group, such as an acrylate. The liquid photopolymer resin also may include monomers that may affect cure rates, crosslink density of the cured resin, viscosity of the liquid photopolymer resin, or the like. Example monomers may include styrene, N-vinylpyrrolidone, acrylates, or the like. The liquid photopolymer resin further may include a photoinitiator.

In some examples, as shown in FIG. 1, additive manufacturing system 10 may cure the liquid photopolymer resin in a top-down orientation. In other examples, additive manufacturing system 10 may cure the liquid photopolymer resin in a bottom-up orientation, in which case the orientation of stage 18, vat 20, and energy delivery device 14 may be vertically flipped (i.e., energy delivery device 14 may be below and focused up toward stage 18).

Energy delivery device 14 may include an energy source, such as a laser source, an electron beam source, plasma source, or another source of energy that may be absorbed by the liquid photopolymer resin. Example laser sources include a CO laser, a CO₂ laser, a Nd:YAG laser, or the like. In some examples, the energy source may be selected to provide energy with a predetermined wavelength or wavelength spectrum that may be absorbed by the liquid photopolymer resin, e.g., a wavelength or wavelength range in the ultraviolet wavelength spectrum.

In some examples, energy delivery device 14 also includes an energy delivery head, which is operatively connected to the energy source. The energy delivery head may focus or direct the energy toward predetermined positions adjacent surface-modified component 22 or within vat 20 during the additive manufacturing technique. As described above, in some examples, the energy delivery head may be movable in at least one dimension (e.g., translatable and/or rotatable) under control of computing device 12 to direct the energy toward a selected location adjacent surface-modified component 22 or within vat 20.

Computing device 12 may include, for example, a desktop computer, a laptop computer, a workstation, a server, a mainframe, a cloud computing system, or the like. Computing device 12 is configured to control operation of additive manufacturing system 10, including, for example, energy delivery device 14, stage 18, or both. Computing device 12 may be communicatively coupled to energy delivery device 14, stage 18, or both using respective communication connections. In some examples, the communication connections may include network links, such as Ethernet, ATM, or other network connections. Such connections may be wireless and/or wired connections. In other examples, the communication connections may include other types of device connections, such as USB, IEEE 1394, or the like.

Computing device 12 may be configured to control operation of energy delivery device 14, stage 18, or both to position surface-modified component 22 relative to energy delivery device 14. For example, as described above, computing device 12 may control stage 18 and energy delivery device 14 to translate and/or rotate along at least one axis to position surface-modified component 22 relative to energy delivery device 14. Positioning surface-modified component 22 relative to energy delivery device 14 may include positioning a structured surface (e.g., a surface to which material is to be added) of surface-modified component 22 in a predetermined orientation relative to energy delivery device 14.

For example, during manufacturing of an additively manufactured component with additive manufacturing system 10, computing device 12 may control movement of energy delivery device 14, stage 18, or both, based on a computer aided manufacturing or computer aided design (CAM/CAD) file. Computing device 12 may control movement of energy delivery device 14 to cause energy beam 28 to trace a desired shape or design in a layer of the liquid photopolymer resin, e.g., a layer of the liquid photopolymer resin adjacent to modified surface 24 of surface-modified component 22, curing the liquid photopolymer resin at locations substantially corresponding to the traced shape or design, e.g., in a layer 26. Computing device 12 then may control stage 18 to move, e.g., away from energy delivery device 14, which may result in uncured liquid photopolymer resin covering the traced shape or design. Computing device 12 may again control movement of energy delivery device 14 to cause energy beam 28 to trace a second desired shape or design in the uncured liquid photopolymer resin on the cured photopolymer, curing the liquid photopolymer resin at locations substantially corresponding to the second traced shape or design. Computing device 12 may control stage 18 and energy delivery device 14 in this manner to result in a plurality of cured photopolymer layers, each layer including a traced shape or design. Together, the plurality of cured photopolymer layers defines an additively manufactured component.

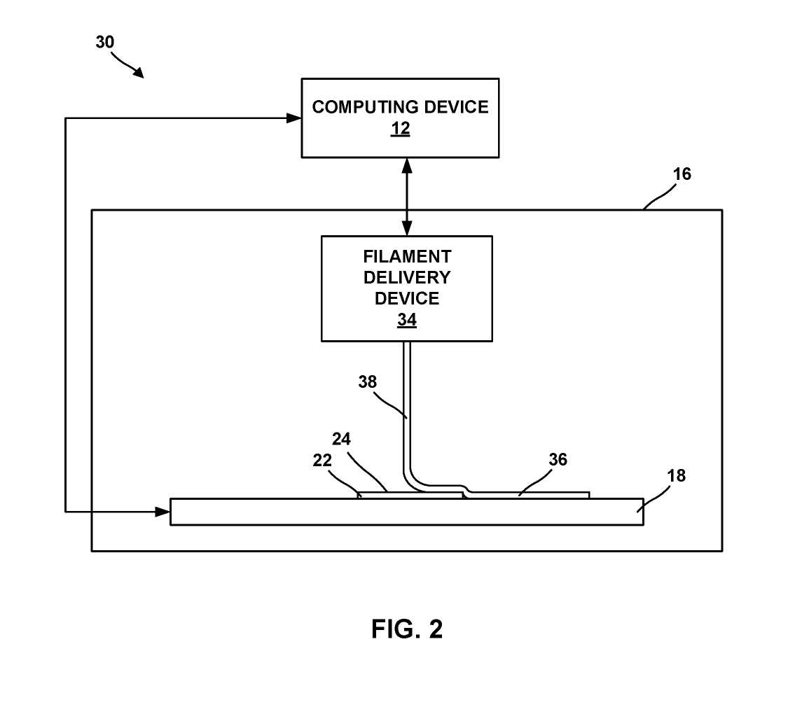

FIG. 1 illustrates a first means for additively forming layers of material using an additive manufacturing technique. FIG. 2 illustrates a second example means for additively forming layers of material using an additive manufacturing technique. FIG. 2 is a conceptual block diagram illustrating another example additive manufacturing system 30 for performing an additive manufacturing technique to form additively manufactured components including features having a minimum size or a minimum radius of curvature that is less than a base resolution of the additive manufacturing technique. Additive manufacturing system 30 is a fused deposition modelling or fused filament fabrication system.

Like additive manufacturing system 10 of FIG. 1, additive manufacturing system 30 may include computing device 12, enclosure 16, and stage 18. Each of these components may be similar to or substantially the same as the respective components in FIG. 1.

Instead of energy delivery device 14, additive manufacturing system 30 includes filament delivery device 34. Filament delivery device 34 may include a filament reel that holds wound filament. The filament may include a polymeric material, such as a thermoplastic. Example thermoplastics include polyolefins, polystyrene, acrylonitrile butadiene styrene, polylactic acid, thermoplastic polyurethanes, aliphatic polyamides, or the like.

Filament delivery device 34 may advance the filament from the reel and heat the filament to above a softening or melting point of the filament. The softened or melted material 38 is then extruded from a nozzle and laid down in a road 36 on modified surface 24 of surface-modified component 22 (or in subsequent layers, on a previously deposited road). The softened or melted material 38 cools and, in this way, is joined to other roads.

Similar to energy delivery device 14, computing device 12 may control movement and positioning of filament delivery device 34 relative to stage 18, and vice versa, to control the locations at which roads 36 are formed. Computing device 12 may control movement of energy delivery device 14, stage 18, or both, based on a computer aided manufacturing or computer aided design (CAM/CAD) file. For example, computing device 12 may control filament delivery device 34 to trace a pattern or shape to form a layer including a plurality of roads on modified surface 24. Computing device 12 may control filament delivery device 34 or stage 18 to move surface-modified component 22 away from filament delivery device 34, then control filament delivery device 34 to trace a second pattern or shape to form a second layer including a plurality of roads on the first layer. Computing device 12 may control stage 18 and filament delivery device 34 in this manner to result in a plurality of layers, each layer including a traced shape or design. Together, the plurality of layers defines an additively manufactured component.

Surface-modified component 22 may be any suitable component to be incorporated into the additively manufactured component. Surface-modified component 22 may provide additional properties or functions to the additively manufactured component. For example, some polymers from which the additively manufactured component is formed may be susceptible to wear due to repeated contact with another surface. To provide better wear resistance to at least a portion of the additively manufactured component, surface-modified component 22 may include a wear resistant or low friction material, such as poly(tetrafluoroethylene) (PTFE).

As another example, surface-modified component 22 may be configured to provide security features to the additively manufactured component, such as anti-theft, anti-tampering, or anti-counterfeiting features. In some implementations surface-modified component 22 may include a radio frequency identification (RFID) tag, a metal or alloy including a patterned surface that produces an optical effect such as iridescence, color, or the like. The RFID tag may store information related to the additively manufactured component, such as a manufacturer, a manufacturing lot or date, a component serial number, or the like. An RFID reader may be used to interrogate the RFID tag to retrieve the information and validate the additively manufactured component. By incorporating the RFID tag with the additively manufactured component, counterfeiting the additively manufactured component may be more difficult. Further, tampering with the RFID tag without detection may be more difficult when the RFID tag is incorporated with the additively manufactured component compared to if the RFID tag is adhered to a surface of the additively manufactured component by an adhesive.

Similarly, a metal or alloy including a patterned surface that produces an optical effect such as iridescence, color, or the like may provide a mark of authenticity for the additively manufactured component. Incorporating the metal or alloy including the patterned surface that produces an optical effect such as iridescence, color, or the like may make tampering with the metal or alloy without detection more difficult compared to if the metal or alloy is adhered to a surface of the additively manufactured component by an adhesive.

As another example, surface-modified component 22 may include a metal or alloy insert configured to contribute to mechanical properties of the additively manufactured component. For example, the metal or alloy insert may be incorporated in the additively manufactured component at a selected location to contribute to tensile or compressive strength at that location, or may include a threaded internal cylindrical surface to facilitate joining of the additively manufactured component to another article while contributing to tensile or compressive strength of the joining.

As an additional example, surface-modified component 22 may include a material having the different hydrophilicity than the polymer used to form the additively manufactured component. For example, surface-modified component 22 may be more hydrophilic than the polymer used to form the additively or may be more hydrophobic than the polymer used to form the additively manufactured component.

Regardless of the of surface-modified component 22, surface-modified component 22 includes at least one modified surface 24. Modified surface 24 is modified to increase adhesion of surface-modified component 22 to the additively manufactured component, e.g., to layer 26 or road 36. In some examples in which surface-modified component 22 includes a polymer or plastic, modified surface 24 may be formed by plasma modification.

Plasma modification uses a plasma and a gas to modify modified surface 24 by causing etching, cleaning, activation, or cross-linking at modified surface 24. For example, plasma modification may result in oxidation or nitridation of modified surface 24 when using a gas that is an oxygen or nitrogen source, respectively. This changes surface activity of modified surface 24, which may allow modified surface 24 to react with layer 26 or road 36.

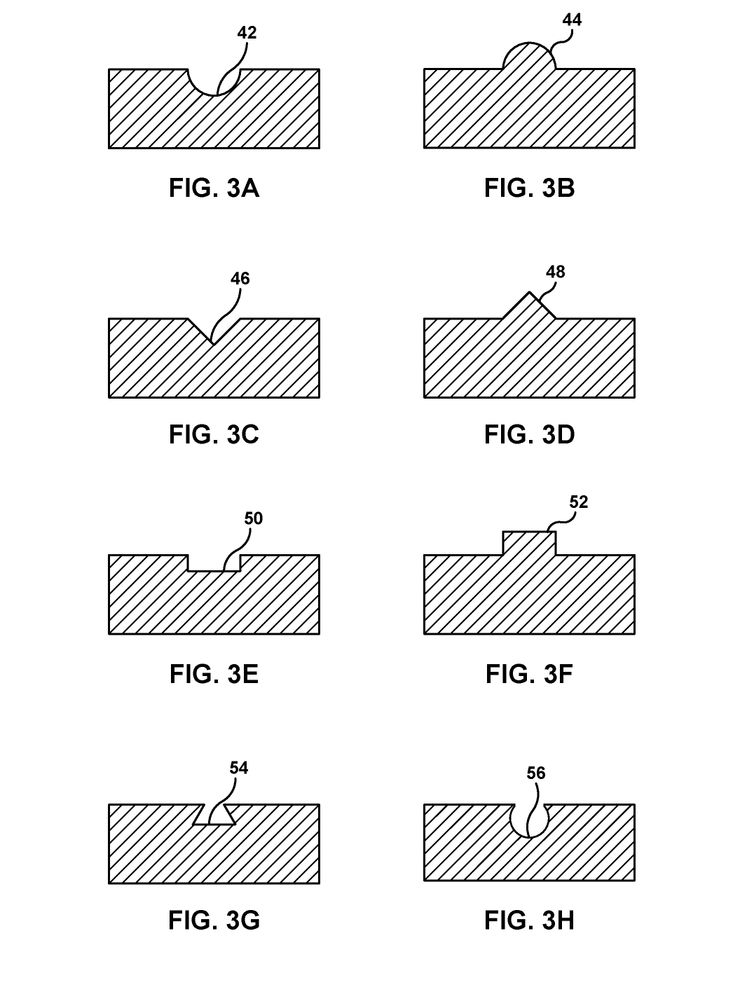

In other examples, modified surface 24 may include three-dimensional surface features configured to increase mechanical adhesion between surface-modified component 22 and the additively manufactured component. The three-dimensional surface features may include, for example, continuous or discrete depressions or grooves, continuous or discrete protrusions or ridges, or combinations thereof. The three-dimensional surface features may include any suitable cross-sectional profile. FIGS. 3A and 3B illustrate a depression or groove 42 and a protrusion or ridge 44, respectively, including a generally curved cross-sectional profile (e.g., groove or ridge having a cross-section of a portion of a circle, or depression or protrusion having a shape of a portion of a sphere). FIGS. 3C and 3D illustrate a depression or groove 46 and a protrusion or ridge 48, respectively, including a triangular cross-sectional profile. For example, a depression 46 or protrusion 48 may comprise a conical shape or a pyramidal shape. FIGS. 3E and 3F illustrate a depression or groove 50 and a protrusion or ridge 52, respectively, having a generally rectangular cross-sectional profile.

FIGS. 3G and 3H illustrate depressions or grooves 54 and 56, respectively, having undercut profile. In various examples, the undercut profile may include various shapes such as a trapezoid (shown in FIG. 3G) or arc (shown in FIG. 3H). Other shapes are contemplated such as a fir tree or keyed shape.

In an undercut configuration, depressions or grooves 54 and 56 may be cut or otherwise formed into modified surface 24 at an angle greater than 90 degrees from the surface plane. In this sense, a width within depressions or grooves 54 and 56 parallel to the surface of the opening may be greater than the width at modified surface 24 defined by the opening of depressions or grooves 54 and 56. By utilizing undercut configurations, the surface area of depressions or grooves 54 and 56 may provide for increased surface area defined by depressions or grooves 54 and 56 compared to that of non-undercut configurations, such as, e.g., square cut or “V” cut configurations. Moreover, the mechanical adhesion between surface-modified component 22 and the additively manufactured component may be increased as the material of the additively manufactured component within the undercut portion of depressions or grooves 54 and 56 must be fractured to remove surface-modified substrate 22 from the additively manufactured component.

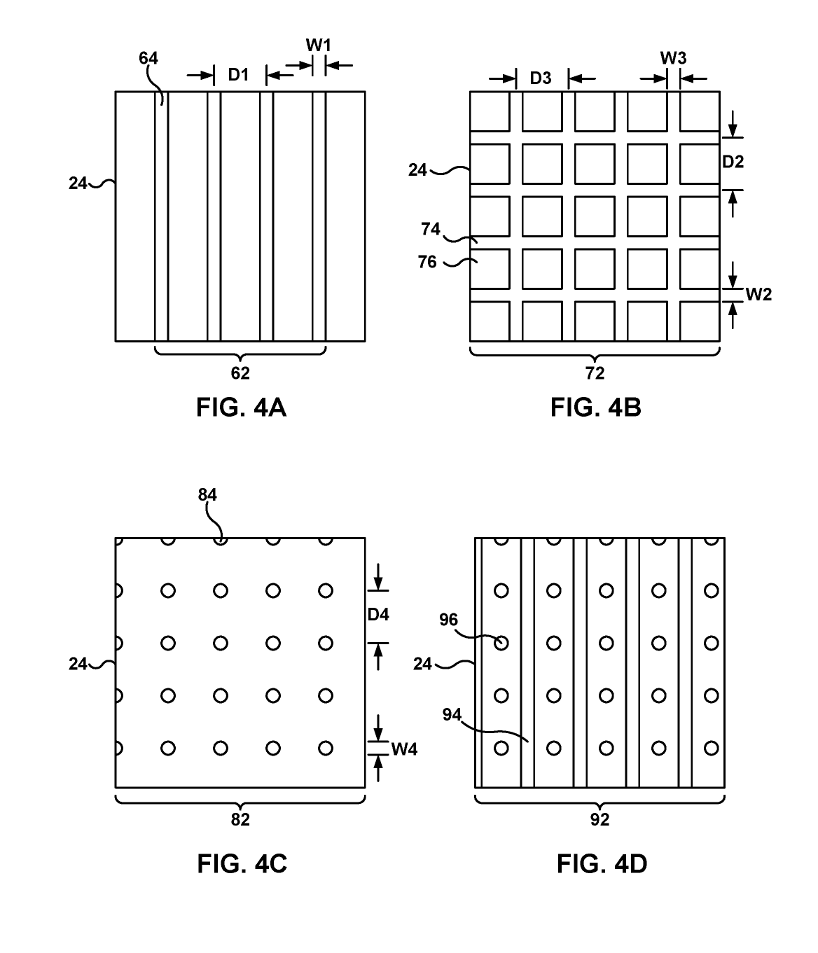

Three-dimensional features 42, 44, 46, 48, 50, 52, 54, or 56 (collectively “3D features 42”) may be formed in modified surface 24 in an array comprising a plurality of 3D features 42. FIGS. 4A-4D illustrate a number of example 3D features 42 and arrays of 3D features 42. For example, FIG. 4A illustrates an array of 3D features 62 including a plurality of grooves or ridges 64 formed in modified surface 24. Grooves or ridges 64 are oriented substantially parallel to each other. Such an arrangement may segregate modified surface 24 into a plurality of domains, each domain being located between adjacent grooves or ridges 64. As described above, this may improve mechanical adhesion of the additively manufactured component to modified surface 24.

In some examples, grooves or ridges 64 may be about the same width W1, as shown in FIG. 4A. In other examples, one or more grooves or ridges 64 may be a different width W1 than another of grooves 64. Adjacent grooves or ridges 64 may be spaced substantially evenly, or may be spaced different distances apart. The distance D1 between adjacent grooves or ridges 64 may be referred to as pitch.

Grooves or ridges 64 may have a variety of cross-sectional shapes, including, for example, any of the cross-sectional shapes illustrated in FIGS. 3A-3H. Each of grooves or ridges 64 may have the same cross-sectional profile, or at least one of grooves or ridges 64 may have a different cross-sectional profile than another one of grooves or ridges 64. The depth of each of grooves or ridges 64 may be the same, or may at least one of grooves or ridges 64 may have a different depth than another one of grooves or ridges 64.

FIG. 4B illustrates an array of features 72 that includes a grid 74 formed by a first plurality of grooves or ridges formed substantially parallel to each other and a second plurality of grooves or ridges formed substantially parallel to each other and substantially perpendicular to the first plurality of grooves or ridges. When grid 72 includes grooves, grid 72 forms a depression in modified surface 24 and defines a plurality of plateaus 76 in modified surface 24. Alternatively, when grid 72 includes ridges, grid 72 forms a protrusion in modified surface 24 and defines a plurality of plateaus 76 in modified surface 24. In this way, grid 72 segregates modified surface 24 into a plurality of domains and improves mechanical adhesion of the additively manufactured component to modified surface 24.

In some examples, each of the grooves or ridges oriented substantially horizontally in FIG. 6B may have a width W2, and each of the grooves or ridges oriented substantially vertically in FIG. 6B may have a width W3. In some examples, width W2 may be the same as width W3, while in other examples width W2 may be different than width W3. In addition, in some examples the width of at least one vertically oriented groove or ridge in grid 72 may be different than the width of another vertically oriented groove or ridge in grid 72. Similarly, the width of at least one horizontally oriented groove or ridge in grid 72 may be different than the width of another horizontally oriented groove or ridge in grid 72.

Adjacent parallel grooves or ridges in grid 72 may be spaced approximately evenly apart, or may be spaced different distances apart. In some examples the distance D1 between adjacent grooves or ridges in a first direction may be different than the distance D2 between adjacent grooves or ridges in a second direction. In some examples, the pitch in one direction may increase or decrease within grid 72, while the pitch in a second direction may be approximately constant.

Each of the grooves or ridges in grid 72 may have a variety of cross-sectional shapes, including, for example, any of the cross-sectional shapes illustrated in FIGS. 3A-3H. Each of the grooves or ridges in grid 72 may have the same cross-sectional profile, or at least one of the grooves or ridges in grid 72 may have a different cross-sectional profile than another one of the grooves or ridges in grid 72. Like the width, the depth or height of each of the grooves or ridges in grid 72 may be approximately the same or the depth or height of at least one of the grooves or ridges may be different than at least one other of the grooves or ridges.

In some examples, modified surface 24 may include an array of discrete 3D features instead of an array of substantially continuous 3D features. For example, FIG. 4C illustrates an array of 3D features 82 that includes a plurality of circular depressions or protrusions 84 formed in modified surface 24. The illustrated patterns and shapes of depressions or protrusions 84 are merely examples, and other patterns and shapes of depressions or protrusions 84 are contemplated by the disclosure. In addition, an array of features may include depressions or protrusions 84 of different shapes, such as circular, hexagonal, or elliptical shapes.

Each of depressions or protrusions 84 may have a diameter or width W4. In some examples, as shown in FIG. 4C, the diameter or width W4 of depressions or protrusions 84 may be substantially constant. In other examples, the diameter or width W4 of at least one of depressions or protrusions 84 may be different than the diameter or width W4 of another one of depressions or protrusions 84. Depressions or protrusions 84 may be spaced approximately evenly apart at a distance D4, or may be spaced different distances apart, like the grooves or ridges in grid 72 illustrated in FIG. 4B.

Each of depressions or protrusions 84 may have one of a variety of cross-sectional shapes, including, for example, any of the cross-sectional shapes illustrated in FIGS. 3A-3H. The cross-sectional profiles of each of depressions or protrusions 84 may be the same or may be different within an array of 3D features 82. The depth of each of depressions or protrusions 84 may be the same or different.

Although substantially continuous features, such as grooves or ridges 64, and discrete features, such as circular depressions or protrusions 84 have been described separately, in some examples, continuous and discrete features may be utilized together. For example, FIG. 4D shows an array of features 92 including a plurality of grooves or ridges 94 and a plurality of circular depressions or protrusions 96. Grooves or ridges 94 are oriented substantially parallel to each other and are formed in modified surface 24 between columns of depressions or protrusions 96. Such an arrangement may segregate modified surface 24 into a plurality of domains, each domain being located between adjacent grooves or ridges 94. As described above, this may improve mechanical adhesion of modified surface 24 to the additively manufactured component.

Depressions or protrusions 96 and grooves or ridges 94 may have characteristics, including depth or height, pitch, width, and/or cross-sectional profile similar to those described above. In some examples, depressions and ridges or grooves and protrusions may be formed together in modified surface 24. Other combinations of depressions, protrusions, grooves, and ridges are also contemplated by the disclosure.

The sizes of the 3D features described in FIGS. 3A-3H and 4A-4D may be selected to increase adhesion of modified surface 24 to the additively manufactured component. In some examples, the 3D features may have a size or radius of curvature smaller than a base resolution of the additive manufacturing technique. For example, the size or radius of curvature may be less than about 1.75 mm, less than about 500 micrometers, less than about 300 micrometers, or less than about 250 micrometers, depending on the base resolution of the additive manufacturing technique. In a stereolithographic printing system, the liquid photopolymer resin may flow into intimate contact with modified surface 24 such that the liquid photopolymer resin accurately reproduces the shape of 3D features 42. Computing device 12 may cause energy delivery device 14 to trace a focal point of energy beam 28 along or around 3D features 42. In some examples, computing device 12 may cause energy delivery device 14 to trace the focal point of energy beam 28 such that the focal point partially overlaps 3D features 42, such that the liquid photopolymer resin is cured at the modified surface 24 to substantially reproduce (e.g., reproduce or nearly reproduce) a complementary shape to modified surface 24 or 54, including 3D features 42. This may result in intimate contact between the additively manufactured component and 3D features 42, resulting in mechanical interference or interlocking and increase mechanical adhesion.

Similarly, in a fused filament deposition technique, softened or melted material 38 may be sufficiently soft or non-viscous to flow into intimate contact with the 3D features 42. Softened or melted material 38 may then cool and harden to substantially reproduce (e.g., reproduce or nearly reproduce) a complementary shape to modified surface 24, including 3D features 42. In this way, modified surface 24 may enable increased mechanical adhesion between surface-modified component 22 and the additively manufactured component.

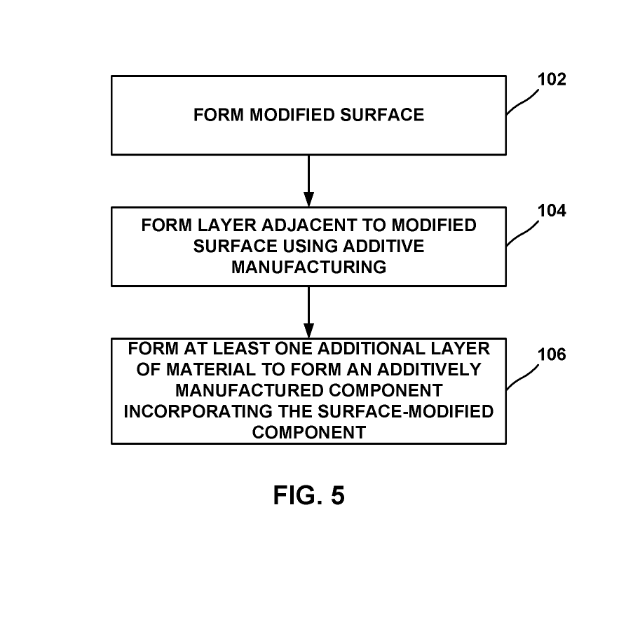

An example technique that may be implemented by system 10 or 30 will be described with concurrent reference to FIG. 5. FIG. 5 is a flow diagram illustrating an example technique for forming an additively manufactured component including at least one feature smaller than a base resolution of the additive manufacturing technique. Although the technique of FIG. 4 is described with respect to system 10 of FIG. 1, in other examples, the technique of FIG. 4 may be performed by other systems, such as system 30 of FIG. 2 or other systems including fewer or more components than those illustrated in FIG. 1. Similarly, systems 10 and 30 may be used to performed other additive manufacturing techniques (e.g., the technique illustrated in FIG. 5).

The technique of FIG. 5 optionally includes forming modified surface 24 in surface-modified component 22 (102). Modified surface 24 may be formed using any suitable technique, including, for example, plasma modification in implementations in which surface-modified component includes a polymer, molding, casting, etching, machining (e.g., milling, grinding, or the like), laser ablation, additive manufacturing in a metal or alloy and post-processing to smooth the surface, or the like.

The technique of FIG. 5 also includes forming a layer 26 of material on modified surface 24 using an additive manufacturing technique (104). For example, in a stereolithographic printing system such as additive manufacturing system 10, the liquid photopolymer resin in vat 20 may flow into intimate contact with modified surface 24 such that the liquid photopolymer resin accurately reproduces the shape of the 3D features of modified surface 24. Computing device 12 may cause energy delivery device 14 to trace a focal point of energy beam 28 along or around the 3D features of modified surface 24 and any other predetermined pattern or shape desired for layer 26. In some examples, computing device 12 may cause energy delivery device 14 to trace the focal point of energy beam 28 such that the focal point partially overlaps modified surface 24, such that the liquid photopolymer resin is cured at the modified surface 24 to substantially reproduce (e.g., reproduce or nearly reproduce) a complementary shape to modified surface 24 and adhere layer 26 to modified surface 24.

The technique of FIG. 5 also includes forming, on layer 26 of material, at least one additional layer of material to form an additively manufactured component including the complementary shape (104). For example, computing device 12 may control movement of energy delivery device 14, stage 18, or both, based on a computer aided manufacturing or computer aided design (CAM/CAD) file. Computing device 12 may control movement of energy delivery device 14 to cause energy beam 28 to trace a desired shape or design in a layer of the liquid photopolymer resin to form each additional layer of material, curing the liquid photopolymer resin at locations substantially corresponding to the traced shape or design. Computing device 12 then may control stage 18 to move, e.g., away from energy delivery device 14, which may result in uncured liquid photopolymer resin covering the traced shape or design. Computing device 12 may again control movement of energy delivery device 14 to cause energy beam 28 to trace a desired shape or design in the uncured liquid photopolymer resin on the cured photopolymer, curing the liquid photopolymer resin at locations substantially corresponding to the traced shape or design. Computing device 12 may control stage 18 and energy delivery device 14 in this manner to result in a plurality of cured photopolymer layers, each layer including a traced shape or design. Together, the plurality of cured photopolymer layers defines an additively manufactured component.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in an article of manufacture including a computer-readable storage medium encoded with instructions. Instructions embedded or encoded in an article of manufacture including a computer-readable storage medium encoded, may cause one or more programmable processors, or other processors, to implement one or more of the techniques described herein, such as when instructions included or encoded in the computer-readable storage medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may include one or more computer-readable storage media.

In some examples, a computer-readable storage medium may include a non-transitory medium. The term “non-transitory” may indicate that the storage medium is not embodied in a carrier wave or a propagated signal. In certain examples, a non-transitory storage medium may store data that can, over time, change (e.g., in RAM or cache).

Various examples have been described. These and other examples are within the scope of the following claims.

What is claimed is:

1. An additive manufacturing assembly comprising:
a surface-modified component to be incorporated into an additively manufactured component by adhering the at least one component to the additively manufactured component during an additive manufacturing technique, wherein the surface-modified component comprises a modified surface that is modified to have increased adhesion to the additively manufactured component;
means for additively forming layers of material using the additive manufacturing technique; and
a computing device configured to:
control the means for additively forming layers to form a layer of material on the surface of the surface-modified component;
control the means for additively forming layers to form, on the layer of material, at least one additional layer of material to form the additively manufactured component incorporating the surface-modified component.

2. The assembly of claim 1, wherein the means for additively forming layers of material comprises:
a fused deposition modeling device comprising a filament delivery device configured to output a heated filament comprising a polymer, wherein the heated filament cools to form the layer of material.

3. The assembly of claim 1, wherein the means for additively forming layers of material comprises:
a stereolithographic device comprising an energy source configured to output energy to selectively cure a photopolymer to form the layer of material.

4. The assembly of claim 1, wherein the surface-modified component comprises at least one of wear resistant insert, an anti-counterfeiting component, a metal or alloy insert, or a material having a different hydrophilicity than the material used to form the additively manufactured component.

5. The assembly of claim 4, wherein the surface-modified component comprises the wear resistant insert, wherein the wear resistant insert comprises a poly(tetrafluoroethylene) insert, and wherein the surface modified to have increased adhesion comprises a plasma-modified surface.

6. The assembly of claim 4, wherein the surface-modified component comprises the metal or alloy insert, wherein the metal or alloy insert comprises a component comprising a threaded internal cylindrical surface, and wherein the surface modified to have increased adhesion comprises three-dimensional surface features configured to improve mechanical adhesion to the additively manufactured component.

7. The assembly of claim 4, wherein the surface-modified component comprises the anti-counterfeiting component, wherein the anti-counterfeiting component comprises a radio frequency identification tag or a metal or alloy component comprising a surface having an interference pattern creating a visible color change, and wherein the surface modified to have increased adhesion comprises three-dimensional surface features configured to improve mechanical adhesion to the additively manufactured component.

8. The assembly of claim 4, wherein the surface-modified component comprises the material having the different hydrophilicity than the material used to form the additively manufactured component, and wherein the surface modified to have increased adhesion comprises three-dimensional surface features configured to improve mechanical adhesion to the additively manufactured component.

9. A method comprising:
forming, on a surface of a surface-modified component to be integrated with an additively manufactured component by adhering the surface-modified component to the additively manufactured component during an additive manufacturing technique, a layer of material using the additive manufacturing technique, wherein the surface is modified to have increased adhesion to the layer; and
forming, on the layer of material, at least one additional layer of material to form the additively manufactured component incorporating the surface-modified component.

10. The method of claim 9, wherein the additive manufacturing technique includes fused deposition modeling or stereolithography.

11. The method of claim 9, wherein the surface-modified component comprises at least one of wear resistant insert, an anti-counterfeiting component, a metal or alloy insert, or a material having a different hydrophilicity than the material used to form the additively manufactured component.

12. The method of claim 11, wherein the surface-modified component comprises the wear resistant insert, resistant insert comprises a poly(tetrafluoroethylene) insert, and wherein the method further comprising plasma modifying a surface of the wear resistant insert to form the surface modified to have increased adhesion.

13. The method of claim 11, wherein the surface-modified component comprises the metal or alloy insert, wherein the metal or alloy insert comprises a component comprising a threaded internal cylindrical surface, and wherein the method further comprises forming a plurality of three-dimensional surface features configured to improve mechanical adhesion to the additively manufactured component in a surface of the metal or alloy insert to form the surface modified to have increased adhesion.

14. The method of claim 11, wherein the surface-modified component comprises the anti-counterfeiting component, wherein the anti-counterfeiting component comprises a radio frequency identification tag or a metal or alloy component comprising a surface having an interference pattern creating a visible color change, and wherein the method further comprises forming a plurality of three-dimensional surface features configured to improve mechanical adhesion to the additively manufactured component in a surface of the anti-counterfeiting component to form the surface modified to have increased adhesion.

15. The method of claim 11, wherein the surface-modified component comprises the material having the different hydrophilicity than the material used to form the additively manufactured component, and wherein the method further comprises forming a plurality of three-dimensional surface features configured to improve mechanical adhesion to the additively manufactured component in a surface of the material having the different hydrophilicity than the material used to form the additively manufactured component to form the surface modified to have increased adhesion.

16. A computer-readable storage device comprising instructions that, when executed, configure one or more processors of a computing device to:
control means for additively forming layers of material using an additive manufacturing technique to form, on a modified surface of a surface-modified component, a layer of material using an additive manufacturing technique, wherein the modified surface is modified to have increased adhesion to the additively manufactured component, and wherein the layer adheres to the modified surface; and
control the means for additively forming layers of material to form, on the layer of material, at least one additional layer of material to form an additively manufactured component incorporating the surface-modified component.

17. The computer-readable storage device of claim 16, wherein the means for additively forming layers of material comprises:
a fused deposition modeling device comprising a filament delivery device configured to output a heated filament comprising a polymer, wherein the heated filament cools to form the layer of material.

18. The computer-readable storage device of claim 16, wherein the means for additively forming layers of material comprises:
a stereolithographic device comprising an energy source configured to output energy to selectively cure a photopolymer to form the layer of material.

19. The computer-readable storage device of claim 16, wherein the surface-modified component comprises at least one of wear resistant insert, an anti-counterfeiting component, a metal or alloy insert, or a material having a different hydrophilicity than the material used to form the additively manufactured component.
